(19) United States
(12) Patent Application Publication
(10) Pub. No.: US 2010/0048424 A1
(43) Pub. Date: Feb. 25, 2010

(54) NANOPARTICLE ARRAY AND METHOD FOR FABRICATING THE SAME

(76) Inventor: Sunghoon Kwon, Seoul (KR)

Correspondence Address: Sunghoon Kwoon;Faculty APT 122I-104, San 4-2, Bongchun 7 Dong, Swank-GU, Seoul, KR

(21) Appl. No.: 12/197,861

(22) Filed: Aug. 25, 2008

(51) Int. Cl. C40B 50/18; C40B 40/06

(52) U.S. Cl. 506/16; 506/32

(57) ABSTRACT

Nanoparticle arrays formed from nanoparticle-bound oligonucleotides bound to single-stranded DNA templates and methods for making the nanoparticle arrays.

### BACKGROUND

The field of nanotechnology encompasses the fabrication of structures that can be measured in nanometers, and the study of the properties of and methods of controlling nano-sized structures. Nanotechnology has been used in applied physics, material science, self-duplication devices, biotechnology, and electronics. Both bottom-up and top-down approaches have been used in the study of nanotechnology.

Traditionally, a top-down approach, based on lithography, has been developed and used in the manufacturing of CMOS devices. However, the use of the traditional, top-down approach limits the possible reduction in size and cost of a semiconductor chip. As a result, bottom-up manufacturing technologies have received increased interest as possible methods of overcoming the limits of the top-down approach. In particular, various synthesized nanostructures, such as carbon nanotubes and inorganic nanowires, have been studied.

In bottom-up manufacturing technologies, it is important to have the ability to locate synthesized materials at a desired position on a wafer.

### SUMMARY

A method for fabricating a nanoparticle array is provided. The method comprises binding a nanoparticle to a plurality of oligonucleotides, binding the oligonucleotides to a single-stranded DNA template to form a double-stranded DNA composite, and attaching the double-stranded DNA composite to a substrate. The single-stranded DNA template can have one or more complementary base sequences that are complementary with respect to the oligonucleotide sequences. The order of carrying out the binding and attaching steps can be varied to provide different variations on the basic method.

The nanoparticles are bound to the 5′ end or the 3′ end of the oligonucleotides. Each of the nanoparticle-bound oligonucleotides is bound to the single-stranded DNA template using a head-to-tail arrangement. The nanoparticles are bound to the 5′ end or the 3′ end of the oligonucleotides. Each of the nanoparticle-bound oligonucleotides is bound to the single-stranded DNA template using a head-to-head arrangement. The nanoparticles comprise at least one of gold, silver, platinum, or copper.

When the nanoparticles comprise gold, the nanoparticles is bound to the oligonucleotides by reacting a thiol group at the 5′ end or the 3′ end of each of the oligonucleotides with a linker on each nanoparticle.

The attaching the double-stranded DNA composite to the substrate comprises exposing a linker on at least one of the 5′ end or the 3′ end of the double-stranded DNA composite with an anchor on the substrate, such that an attachment is formed via an interaction between the linker and the anchor. The anchor comprises gold and the linker comprises a thiol.

The distance between the nanoparticles positioned in the double-stranded DNA composite is about 4 nm or less. The nanoparticles have an average diameter of about 1 nm to 1.5 nm.

A method for fabricating a nanoparticle array is provided. The method comprises attaching a single-stranded DNA template to a substrate, and binding a plurality of oligonucleotides to the single-stranded DNA template so as to form a double-stranded DNA composite, wherein each of the oligonucleotides is bound to a nanoparticle. The single-stranded DNA template can have one or more complementary base sequences that are complementary with respect to the oligonucleotide sequences. The order of carrying out the binding and attaching steps can be varied to provide different variations on the basic method.

The distance between the nanoparticles in the double-stranded DNA composite is about 4 nm or less. The nanoparticles are bound to the 5′ end or the 3′ end of each of the oligonucleotides. Each of the nanoparticle-bound oligonucleotides is bound to the single-stranded DNA template using a head-to-tail arrangement, such that the distance between the nanoparticles positioned in the double-stranded DNA composite is substantially uniform.

The nanoparticles are bound to the 5′ end or the 3′ end of each of the oligonucleotides and each of the nanoparticle-bound oligonucleotides is bound to the single-stranded DNA template using a head-to-head arrangement. The nanoparticles comprise at least one of gold, silver, platinum, or copper.

When the nanoparticles comprise gold, the nanoparticles are bound to linkers, each of the oligonucleotides comprises a thiol group at the 5′ end or a 3′ end, and the nanoparticles are bound to the oligonucleotides by reacting the thiol groups with the linkers.

The attaching the single-stranded DNA template on the substrate comprises exposing a gold anchor on the substrate to a thiol group at at least one of the 5′ end or the 3′ end of the single-stranded DNA template, such that an attachment is formed via an interaction between the gold anchor and the thiol group.

A nanoparticle array fabricated by the method described above is provided.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1A is a diagram of an illustrative embodiment of the binding of oligonucleotides to nanoparticles.

FIG. 1B is a diagram of an illustrative embodiments of oligonucleotide-nanoparticle conjugates.

FIGS. 1C to 1F are diagrams, of illustrative embodiments of a double-stranded DNA composite which is formed by binding the oligonucleotide-nanoparticle conjugates shown in FIG. 1B with a single-stranded DNA template.

FIG. 2 is a diagram of an illustrative embodiment of a double-stranded DNA composite including nanoparticles attached to a substrate.

FIG. 3 is a diagram of an illustrative embodiment of a substrate in which a plurality of double-stranded DNA composites, each including nanoparticles, is attached on a surface of a substrate.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In one embodiment, a method for fabricating a nanoparticle array comprises binding at least one nanoparticle to each of a plurality of oligonucleotides, binding each of the nanoparticle-bound oligonucleotides to a single-stranded DNA template to form a double-stranded DNA composite, and attaching the double-stranded DNA composite to a substrate. The single-stranded DNA template can have one or more base sequences that are complementary with respect to the oligonucleotide sequences, such that the oligonucleotides can specifically bind at predetermined locations along the single-stranded DNA template.

The distance between the nanoparticles positioned in the double-stranded DNA composite can be controlled by controlling the length of each of the oligonucleotides, and/or the base sequence of the DNA template, wherein the nanoparticles are bound to the 5′ end or the 3′ end of the oligonucleotides. The distance between the nanoparticles positioned in the double-stranded DNA composite can also be controlled by binding each of the oligonucleotides bound to the nanoparticles with the single-stranded DNA template using a head-to-tail or head-to-head arrangement. Here, the nanoparticles can comprise, for example, one or more of gold, silver, platinum, copper, or the like.

In one embodiment, the nanoparticles comprise gold, and binding the nanoparticles to the oligonucleotides comprises binding the nanoparticles to the oligonucleotides by reacting the thiol groups at the 5′ and 3′ end of the oligonucleotides with linkers attached to the nanoparticles. The double-stranded DNA composite may be attached to the substrate by exposing a linker on the 5′ end or the 3′ end of the double-stranded DNA composite to an anchor on the substrate, such that an attachment is formed via an interaction between the linker and the anchor. Here, the anchor may comprise gold, and the linker may comprise a thiol linker. However, the linkers and anchors may comprise any chemical entities (e.g., molecules or functionalities) that are capable of binding to a DNA composite, nanoparticle or substrate (as appropriate) and providing a bond or attachment between an oligonucleotide and a nanoparticle or between a DNA composite and a substrate (as appropriate).

Each of the nanoparticle-bound oligonucleotides may be bound to the single-stranded DNA template such that a distance between the nanoparticles positioned in the double-stranded DNA composite is about 4 nm or less. The nanoparticle can have an average diameter of no greater than about 500 nm, no greater than about 100 nm, or no greater than about 10 nm, although nanoparticles having diameters outside these ranges can also be used. For example, the nanoparticles may, but do not necessarily, have an average diameter size of about 1 nm to 1.5 nm.

In another embodiment, a method for fabricating a nanoparticle array may comprise attaching a single-stranded DNA template to a substrate, and binding a plurality of oligonucleotides to the single-stranded DNA template to form a double-stranded DNA composite, wherein each of the oligonucleotides is bound to a nanoparticle. The distance between the nanoparticles positioned in the double-stranded DNA composite can be controlled by controlling the length of each of the oligonucleotides, wherein the nanoparticles can be bound to the 5′ end or the 3′ end of each of the oligonucleotides. One embodiment of the method further comprises binding each of the nanoparticle-bound oligonucleotides to the single-stranded DNA template using a head-to-tail or head-to-head arrangement, such that the distance between the nanoparticles positioned in the double-stranded DNA composite is substantially uniform. Here, the distance may be about 4 nm or less, and the nanoparticles may comprise at least one of gold, silver, platinum, copper, or the like.

In one embodiment, the nanoparticles comprise gold and are bound to linkers. In this embodiment each of the oligonucleotides comprises a thiol group at the 5′ end or the 3′ end, and the nanoparticles are bound to the oligonucleotides by reacting the thiol groups with the linkers.

Attaching a single-stranded DNA template to the substrate may comprise attaching one or more gold anchors to the substrate, attaching a thiol group at the 5′ end and/or the 3′ end of the single-stranded DNA template, and attaching the single-stranded DNA template to the substrate by reacting the thiol groups with the anchors. The use of a DNA template in this manner enables the nanoparticles to be attached at desired positions on the substrate. In particular, the length of the oligonucleotides attached to the nanoparticles and complimentarily bound to the DNA template can be selected to accurately control the distance between the nanoparticles.

Nanoparticle arrays fabricated by a method described above are also provided.

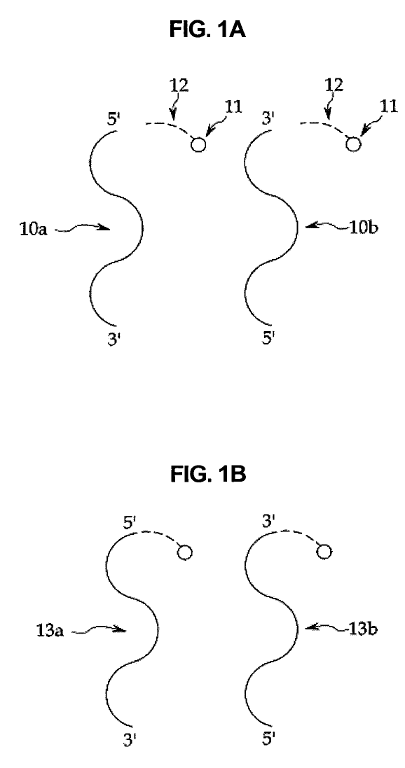

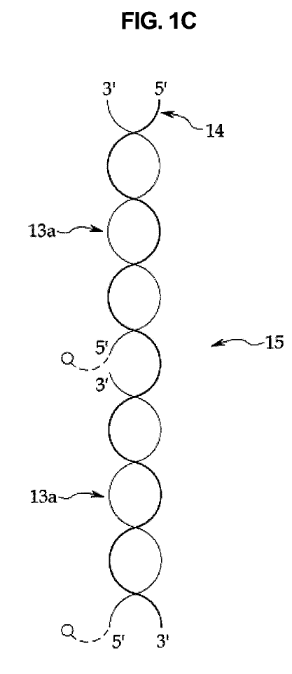

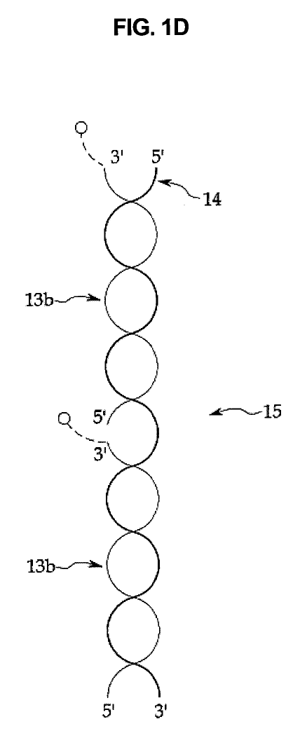

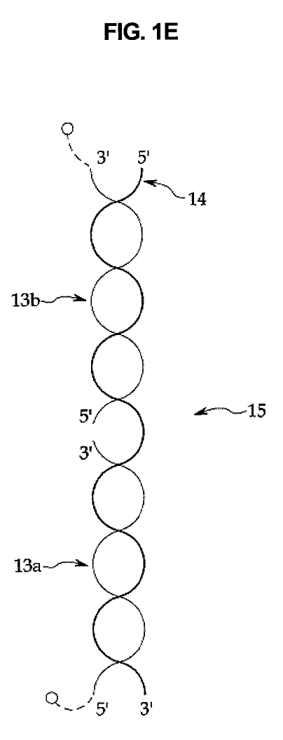

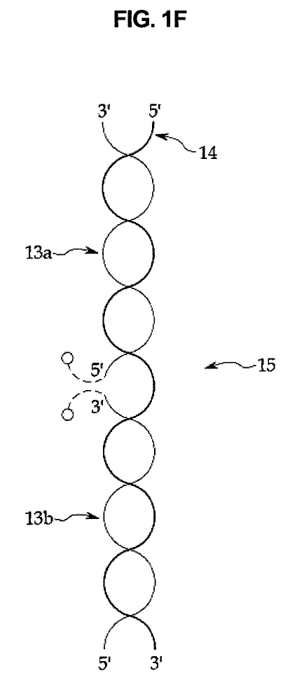

FIGS. 1A to 1F illustrate a method for binding nanoparticles to a single-stranded DNA template using oligonucleotides.

FIG. 1A is a diagram illustrating oligonucleotides 10a and 10b bound to nanoparticles 11. Here, the nanoparticles 11 can be made of materials such as, gold, silver, platinum, or copper, but various kinds of nanoparticles can be used as necessary.

The oligonucleotides 10a and 10b used in this embodiment may be fabricated to have a uniform length and base sequences. For example, Applied Biosystems Model 391 DNA Synthesizer may be used to synthesize the oligonucleotides 10a and 10b. The base sequences of the oligonucleotides 10a and 10b are complementary to the base sequences along a single-stranded DNA template 14, shown in FIG. 1C. The length of the oligonucleotides 10a and 10b may be appropriately adjusted to correspond to a desired distance between the nanoparticles to be arranged on a substrate. For example, the oligonucleotides 10a and 10b may have a length of about 4 nm or less, such that when the nanoparticles are arranged on a substrate, the distance between the nanoparticles is 4 nm.

According to one embodiment, gold nanoparticles may be used. The gold nanoparticles may be bound to the oligonucleotides using a thiol having compatibility with gold. For example, if a gold nanoparticle is bound to a linker 12, the gold nanoparticle 11 may be bound to an oligonucleotide 10a or 10b in which a 5′ end or a 3′ end of the oligonucleotide is thiol-terminated. A linker capable of interacting and binding to the thiol group may be used as the linker 12. For example, the linker 12 may be a linker including the maleimido group.

The 5′ end or 3′ end of each oligonucleotide may be thiol-terminated by capping the 5′ end or the 3′ end of each of the oligonucleotides with S-trityl-6-mercaptohexylphosphoramidite or using 1-O-dimethoxytritylpropyldisulphide-1-succinoyl support. As a result, a sulphydryl group may be introduced to the 5′ end or the 3′ end of each of the oligonucleotides. The method of introducing the sulphydryl group to the 5′ end or the 3′ end of each of the oligonucleotides is not limited to the aforementioned method.

The gold nanoparticles 11 bound to the linkers 12 can be bound to the oligonucleotides 10a or 10b by a chemical reaction between the linkers 12 and the thiol-terminated 5′ end or 3′ end of the oligonucleotides, so as to form an oligonucleotide-nanoparticle conjugate 13a and 13b. FIG. 1B illustrates the oligonucleotide-nanoparticle conjugates 13a and 13b formed by binding the nanoparticles 11 to the 5′ end or the 3′ end of oligonucleotides 10a or 10b with the linkers 12. A gold nanoparticle 11 may be bound to the thiol-terminated 5′ end or 3′ end of an oligonucleotide using a buffer solution containing 20 mM NaH₂PO₄, 150 mM NaCl and 1 mM EDTA of pH 6.5, which contains 10% isopropanol at a temperature of 4° C. for 24 hours.

FIGS. 1C to 1F each illustrate a double-stranded DNA composite 15 formed by binding the oligonucleotide-nanoparticle conjugates 13a and 13b shown in FIG. 1B to the single-stranded DNA template 14. As described above, because the single-stranded DNA template 14 has base sequences complementary to the base sequences of the oligonucleotides 10a and 10b, the single-stranded DNA template 14 may be bound to the oligonucleotide-nanoparticle conjugates 13a and 13b by a Watson-Crick base pairing. The single-stranded DNA template 14 may be manufactured to have the desired length and base sequences using the same methods as those used for synthesizing oligonucleotides, e.g., Applied Biosystems Model 391 DNA Synthesizer. For example, if the single-stranded DNA template 14 has the base sequence of 5′-TGACTGACTGCCTGACTGTTGACTGACTGCCTGACTG-3′ (SEQ ID NO.:1), the oligonucleotide 10a can have the base sequence of 5′-HS-CAGTCAGGCAGTCAGTCA-3′ (SEQ ID NO.:2) and the oligonucleotide 10b can have the base sequence of 5′-CAGTCAGGCAGTCAGTCA-SH-3′ (SEQ ID NO.:3), such that both oligonucleotides can be bound to the single-stranded DNA template 14 through complementary base sequences. As a result, the double-stranded DNA composite 15 is formed.

As shown in FIGS. 1C and 1D, the oligonucleotide-nanoparticle conjugates 13a and 13b may be bound to the single-stranded DNA template 14 in a head-to-tail arrangement. Attentively, as shown in FIGS. 1E and 1F, the oligonucleotide-nanoparticle conjugates 13a and 13b may be bound to the single-stranded DNA template 14 in a head-to-head arrangement. The double-stranded DNA composite 15 can be self-assembled by hydrogen bonding between purine and pyrimidine bases included in the oligonucleotides and the DNA template 14.

In the double-stranded DNA composite 15 shown in FIGS. 1C and 1D, the nanoparticles 11 bound to the single-stranded DNA template 14 are spaced apart from each other. A distance between the nanoparticles 11 may be similar to the length of each of the oligonucleotides 10. For example, in FIGS. 1C and 1D, if the length of the oligonucleotide 10 is 4 nm, the distance between the nanoparticles 11 can be about 4 nm. This illustrates that by controlling the length of each of the oligonucleotides 10 bound to the nanoparticles 11, the distance between the nanoparticles 11 can be controlled.

Although FIGS. 1C to 1F illustrate double-stranded DNA composites formed by binding two oligonucleotides to the DNA template strand having 37 bases. The number of the base sequences and the length of the oligonucleotides can be appropriately adjusted, according to the desired length of the nanoparticle array and the desired distance between the nanoparticles. Moreover, the length of the DNA template may be freely adjusted depending on the desired length of a target composite.

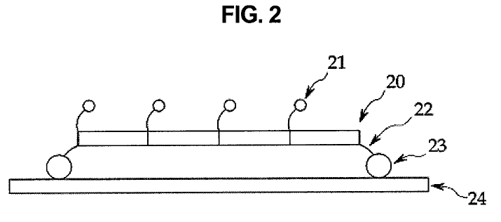

As shown in FIG. 2, a double-stranded DNA composite may be attached to a substrate 24. The substrate 24 used in this embodiment may be a silicon wafer used for fabricating integrated circuits, but is not limited thereto. The attachment may be formed by first forming, or otherwise providing anchors on the substrate. The anchors may be gold; however, any material may be used as an anchor 23 as long as the material is capable of attaching the DNA composite 20 to the substrate 24. The gold anchors 23 used in this embodiment can have, for example, a size of 2 nm or less. The gold anchors 23 may be attached at positions on the substrate 24 where DNA composite is to be fixed. Next, linkers 22 capable of binding to the anchors 23 can be formed, or otherwise provided, at the 5′ end and the 3′ end of the DNA composite 20. If the anchors 23 are gold, thiol linkers 22 having compatibility with gold may be formed at the 5′ end and the 3′ end of the DNA composite 20. The methods for forming the thiol linkers 22 at the 5′ end and the 3′ end of the DNA composite 20 may be same as those for forming a thiol group at the end of an oligonucleotide.

The DNA composite 20 having the thiol linker 22 at its 5′ end and 3′ end may be attached on the substrate 24 on which the gold anchor 23 is attached, by reacting the thiol linker 22 with the gold anchor 23 by, for example, reacting the thiol linkers 22 and the gold anchors 23 in a buffer solution containing 20 mM NaH₂PO₄, 150 mM NaCl, and 1 mM EDTA of pH 6.5, which contains 10% isopropanol at a temperature of 4° C. for 24 hours.

As described above, the DNA composite 20 may be attached at a specific position of the substrate 24 through the anchors 23. Thus, the nanoparticles 21 bound to the DNA composite 20 may be attached at specific positions on the substrate 24. In addition, the length of the oligonucleotides to which the nanoparticles 21 are attached and the attachment points between the oligonucleotide-nanoparticle conjugates and the single-stranded DNA template may be selected to control the distance between the nanoparticles positioned in the DNA composite.

A nanoparticle array in which nanoparticles can be substantially uniformly positioned may be formed by using a plurality of double-stranded DNA composites. For example, multiple anchors may be attached on the substrate in a predetermined pattern. For example, the anchors may be arranged on the substrate in parallel with a horizontal axis of the substrate. Then, the double-stranded DNA composites, each having linkers at their 5′ end and/or 3′ end, may be attached on the anchors by reacting the anchors and the linkers. Because each of the double-stranded DNA composites comprises bound nanoparticles separated by a predetermined distance, and the double-stranded DNA composites are attached on the substrate in the predetermined pattern, the substrate can have the nanoparticles arranged at the predetermined distance according to the pattern in which the anchors are arranged.

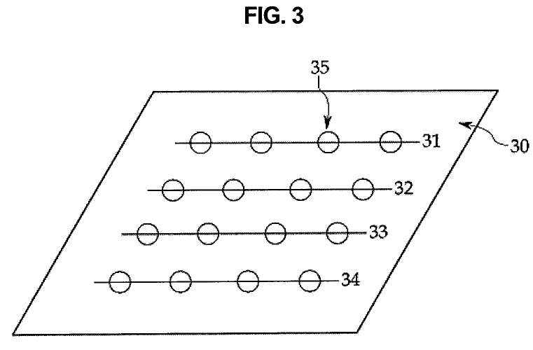

FIG. 3 illustrates a substrate on which a plurality of double-stranded DNA composites is attached. Referring to FIG. 3, four double-stranded DNA composites 31, 32, 33, and 34 are attached on the substrate 30. Each double-stranded DNA composite includes a plurality of nanoparticles 35. Each nanoparticle 35 is separated by a distance. As described with reference to FIG. 3, the double-stranded DNA composites 31, 32, 33, and 34 are attached on the substrate 30 by the reaction between the linkers (not shown) attached at the 5′ end and the 3′ end of the composites and the corresponding anchors attached on the substrate 30. If the distance between the nanoparticles 35 positioned in the double-stranded DNA composites 31, 32, 33 and 34 is about 4 nm, the distance between nanoparticles positioned in neighboring double-stranded DNA composites attached on the substrate 30 can be 4 nm, depending upon the spacing between neighboring DNA composites.

The pattern of the nanoparticles arranged on the substrate may vary according to the pattern in which the double-stranded DNA composites including the nanoparticles are arranged on the substrate. Further, the distance between the nanoparticles arranged on the substrate may vary according to the length of the oligonucleotides included in the double-stranded DNA composite and/or the binding arrangement of the oligonucleotides to the single-stranded DNA template. Therefore, according to various embodiments, a nanoparticle array having a desired inter-particle distance and pattern may be fabricated.

From the foregoing, it will be appreciated that specific embodiments of the present disclosure have been described herein for purposes of illustration, and that various modifications may be made without deviating from the spirit and scope of the present disclosure. Thus, the described embodiments are to be considered in all respects only as illustrative, and not restrictive. The scope of the present disclosure is, therefore, indicated by the appended claims, rather than by the foregoing description. All changes within the meaning and range of equivalency of the claims are to be embraced within their scope.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

### Equivalents

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for fabricating a nanoparticle array, comprising:
binding at least one nanoparticle to each of a plurality of oligonucleotides;
binding each of the nanoparticle-bound oligonucleotides to a single-stranded DNA template to form a double-stranded DNA composite; and
attaching the double-stranded DNA composite to a substrate.

2. The method of claim 1, wherein the nanoparticles are bound to the 5′ end or the 3′ end of the oligonucleotides, and
each of the nanoparticle-bound oligonucleotides is bound to the single-stranded DNA template using a head-to-tail arrangement.

3. The method of claim 1, wherein the nanoparticles are bound to the 5′ end or the 3′ end of the oligonucleotides, and
each of the nanoparticle-bound oligonucleotides is bound to the single-stranded DNA template using a head-to-head arrangement.

4. The method of claim 1, wherein the nanoparticles comprise at least one of gold, silver, platinum, or copper.

5. The method of claim 1, wherein the nanoparticles comprise gold, and
further wherein binding the nanoparticles to the oligonucleotides comprises reacting a thiol group at the 5′ end or the 3′ end of each of the oligonucleotides with a linker on each nanoparticle.

6. The method of claim 1, wherein attaching the double-stranded DNA composite to the substrate comprises exposing a linker on at least one of the 5′ end or the 3′ end of the double-stranded DNA composite with an anchor on the substrate, such that an attachment is formed via an interaction between the linker and the anchor.

7. The method of claim 6, wherein the anchor comprises gold and the linker comprises a thiol.

8. The method of claim 1, wherein the distance between the nanoparticles positioned in the double-stranded DNA composite is about 4 nm or less.

9. The method of claim 1, wherein the nanoparticles have an average diameter of about 1 nm to about 1.5 nm.

10. A method for fabricating a nanoparticle array, comprising:
attaching a single-stranded DNA template to a substrate; and
binding a plurality of oligonucleotides to the single-stranded DNA template so as to form a double-stranded DNA composite, wherein each of the oligonucleotides is bound to a nanoparticle.

11. The method of claim 10, wherein the distance between the nanoparticles in the double-stranded DNA composite is about 4 nm or less.

12. The method of claim 10, wherein the nanoparticles are bound to the 5′ end or the 3′ end of each of the oligonucleotides and each of the nanoparticle-bound oligonucleotides is bound to the single-stranded DNA template using a head-to-tail arrangement, such that the distance between the nanoparticles positioned in the double-stranded DNA composite is substantially uniform.

13. The method of claim 10, wherein the nanoparticles are bound to the 5′ end or the 3′ end of each of the oligonucleotides and each of the nanoparticle-bound oligonucleotides is bound to the single-stranded DNA template using a head-to-head arrangement.

14. The method of claim 9, wherein the nanoparticles comprise at least one of gold, silver, platinum, or copper.

15. The method of claim 9, wherein the nanoparticles comprise gold, the nanoparticles are bound to linkers, each of the oligonucleotides comprises a thiol group at the 5′ end or a 3′ end, and the nanoparticles are bound to the oligonucleotides by reacting the thiol groups with the linkers.

16. The method of claim 9, wherein attaching the single-stranded DNA template on the substrate comprises exposing a gold anchor on the substrate to a thiol group at at least one of the 5′ end or the 3′ end of the single-stranded DNA template, such that an attachment is formed via an interaction between the gold anchor and the thiol group.

17. A nanoparticle array fabricated by the method of claim 1.

18. A nanoparticle array fabricated by the method of claim 9.
